(19) United States
(12) Patent Application Publication
(10) Pub. No.: US 2011/0256379 A1
(43) Pub. Date: Oct. 20, 2011

(54) BODY ASSEMBLED WITH A MACROPOROUS HARDENED CEMENT

(75) Inventors: Gaetan Champagne, L'Isle Sur La Sorgue (FR); Adrien Vincent, Cabannes (FR); Anthony Briot, Saint Saturnin Les Avignon (FR); Patrick Girot, Salon De Provence (FR)

(73) Assignee: SAINT-GOBAIN CENTRE DE RECHERCHES ET D'ETUDES EUROPEEN, Courbevoie (FR)

(21) Appl. No.: 13/126,599

(22) PCT Filed: Oct. 30, 2009
(86) PCT No.: PCT/IB2009/054834

§ 371 Date: Jun. 28, 2011

(30) Foreign Application Priority Data
Oct. 30, 2008 (FR) 08 57417

(51) Int. Cl. B32B 3/26; B29C 39/38

(52) U.S. Cl. 428/304.4; 264/45.3

(57) ABSTRACT

An assembled ceramic body having blocks attached to one another by means of a seal, the lateral surface of the ceramic body possibly being coated with a peripheral coating, the seal and/or the peripheral coating including a set cement having less than 10% of inorganic fibers, as a percentage by weight based on the dry mineral matter, in a section plane perpendicular to at least one of the facing faces of the blocks assembled by said seal, having macropores with an equivalent diameter in the range 200 μm to 40 mm in a quantity such that the total surface area in said section plane occupied by said macropores represents more than 15% and less than 80% of the total surface area observed.

### FIELD OF THE INVENTION

The invention provides an assembled ceramic body, in particular for filtering exhaust gas from an automotive vehicle, said assembled body comprising a plurality of blocks attached together by means of a seal interposed between said blocks.

### PRIOR ART

Before being evacuated into the atmosphere, the exhaust gases from an automotive vehicle may be purified by means of a particle filter that is known from the prior art, such as that shown in FIGS. 1 and 2. Identical references were used in the various figures to indicate means that are identical or similar.

A particle filter 1 is shown in FIG. 1 in cross-section along the section plane B-B of FIG. 2, and, in FIG. 2, in longitudinal section along the section plane A-A of FIG. 1.

The particle filter 1 conventionally comprises at least one filter body 3, having a length L, inserted in a metal can 5.

The filter body 3 may be monolithic. Nevertheless, in order to improve its thermomechanical strength, in particular during regeneration phases, it has proved to be advantageous for it to be the result of assembling and machining a plurality of blocks 11, with references 11a-11i. It is then termed an “assembled” filter body.

In order to manufacture a filter block 11, a ceramic material (cordierite, silicon carbide, etc.) is extruded so as to form a porous honeycomb structure. The extruded porous structure conventionally has the form of a rectangular parallelepiped extending between two substantially square upstream 12 and downstream 13 faces, into which a plurality of adjacent, rectilinear and parallel channels 14 open out.

WO 05/016491, for example, shows that porous honeycomb structures with channels of section that varies depending on the channel under consideration are also known. Those structures, termed “asymmetric structures”, generally offer a large storage volume and limit the pressure drop across the filter.

After extrusion, the extruded porous structures are alternately plugged on the upstream face 12 or the downstream face 13 by respective upstream and downstream plugs 15s and 15e as is well known, to form channels of the “outlet channel” and “inlet channel” types 14s and 14e, respectively. At the ends of the outlet and inlet channels 14s and 14e remote from the upstream and downstream plugs 15s and 15e, respectively, the outlet and inlet channels 14s and 14e open to the outside via outlet and inlet openings 19s and 19e, respectively, extending over the downstream and upstream faces 13 and 12 respectively. The inlet and outlet channels 14s and 14e thus define internal spaces 20e and 20s, defined by a side wall 22e and 22s, a sealing plug 15e and 15s, and a respective opening 19s or 19e that opens to the outside. Two adjacent inlet and outlet channels 14s and 14e are in fluid communication via the common portion of their side walls 22e and 22s.

After plugging, the extruded porous structures are sintered.

The filter blocks produced thereby, which are rectangular parallelpipeds, each have four outer planar faces extending from the upstream face 12 to the downstream face 13.

In order to assemble the filter blocks, the facing outer faces, below termed the “seal faces”, are bonded by means of seals 27₁₋₁₂ formed from a ceramic cement generally constituted by silica and/or silicon carbide and/or aluminum nitride.

To constitute the ceramic cement of the seals 27₁₋₂ of the assembly of filter blocks, or “ceramic seal layer”, a set cement in particular is known that comprises in the range 30% to 60% by weight of silicon carbide. The silicon carbide has a high thermal conductivity that advantageously means that the temperature in the filter body can rapidly be homogenized. However, silicon carbide has a relatively high expansion coefficient. The silicon carbide content of that type of set cement must therefore be limited in order to provide thermomechanical strength that is adapted to being applied to particle filters.

The assembly constituted thereby may then be machined in order to assume a round section, for example. The set cement must be capable of resisting that machining operation.

Preferably, a peripheral coating 27′ is also applied so as to cover substantially the entire lateral surface of the filter body. The result is a cylindrical filter body 3 with a longitudinal axis C-C, which can be inserted in the can 5; a peripheral material 28, which is exhaust gas-tight, is disposed between the outer filter blocks 11a-11h, or, if necessary, between the coating 27′, and the can 5. The set cement used for the seals 27₁₋₁₂ may optionally be employed to produce the peripheral coating 27′. In that case, it must have sufficient mechanical strength to resist insertion into the can, or “canning”.

As the arrows shown in FIG. 2 indicate, the exhaust gas stream F enters the filter body 3 through the openings 19e of the inlet channels 14e, passes through the filtering side walls of those channels to join the outlet channels 14s, and then escapes to the outside via the openings 19s.

A seal must be exhaust gas-tight to exhaust gases in order to constrain the gases to pass through the filtering walls separating the inlet channels and the outlet channels.

After a certain time of use, the particles, or “soot”, accumulated in the channels of the filter body 3 increase the pressure drop due to the filter body 3, thus altering the performance of the engine. For this reason, the filter body has to be regenerated regularly, for example every 500 kilometers.

Regeneration, or “cleaning”, consists in oxidizing the soot. To accomplish this, it is necessary to heat it to a temperature allowing it to ignite. The lack of homogeneity of the temperatures within the filter body 3 and possible differences in the nature of the materials used for the filter blocks 11a-11i and seals 27₁₋₁₂ can then generate strong thermomechanical stresses. The cement of the seal must be capable of resisting thermomechanical stresses during regeneration.

The stresses on the seals are particularly severe with assemblies of filter blocks with an asymmetric structure, i.e. in which the cross-sections of the inlet channels are different from those of the outlet channels. These blocks, which are weakened due to large proportion by weight constituted by the sealing plugs, have a tendency to separate one from the other. The set cement may also have a tendency to fracture.

The stresses are also very high in the event of spontaneous or poorly controlled regeneration.

It is known, from EP 0 816 065 for example, that incorporating ceramic fibers into the set cement makes it possible to increase the elasticity of the seal, and thus the thermomechanical strength of the assembled filter body. However, with the presence of ceramic fibers, a potential risk arises as regards health and safety, making recycling the filter body more difficult. Moreover, the incorporation of fibers, in particular with a reduced presence of shot (non-fibrous particles), is particularly expensive.

Finally, the ceramic fibers make it difficult to distribute the fresh cement uniformly during its application to the surfaces of the blocks to be assembled.

Furthermore, EP 1 142 619 describes an assembled filter body employing a set cement with low thermal conductivity; the use of a conductive set cement is considered to be prejudicial to adhesion and to thermal resistance.

EP 1 479 882 describes an assembled filter body and recommends parameters that accommodate the thermal expansion coefficients of the seal and the filter blocks. The degree of porosity of the seal may be controlled by adding a foaming agent or a resin.

EP 1 437 168 deals with the thermal heterogeneity between the periphery and the central portion of the filter and recommends a set cement and filter blocks having particular thermal conductivities and densities.

EP 1 447 535 also proposes taking into account the thickness of the seal and the thickness of the outer wall of the filter blocks.

FR 2 902 424 discloses a set cement comprising silicon carbide (SiC) and hollow spheres, at least 80% by number of said hollow spheres having a dimension in the range 5 micrometers (μm) to 150 μm.

FR 2 902 423 discloses a set cement having a silicon carbide (SIC) content in the range 30% to 90% and a thermoset resin.

There is thus a need for an assembled ceramic body, in particular a ceramic body comprising blocks with an asymmetric structure, capable of effectively resisting the above-mentioned stresses and suitable for application to filtering exhaust gas from internal combustion engines, especially diesel engines.

One aim of the present invention is to satisfy this need.

### SUMMARY OF THE INVENTION

In accordance with a first main embodiment of the invention, this aim is achieved by means of an assembled ceramic body, in particular an assembled filter body, comprising blocks attached to each other by means of a seal, the lateral surface of the ceramic body possibly being coated with a peripheral coating, the seal and/or the peripheral coating comprising, preferably being constituted by, a set cement, said set cement, in particular the set cement of said seal, in a section plane perpendicular to at least one of the facing faces of the blocks assembled by said seal, having pores with an equivalent diameter in the range 200 μm to 40 millimeters (mm) (below termed “macropores”), in a quantity such that, in said section plane, the total surface area occupied by said macropores represents more than 15%, preferably more than 20%, and, preferably, less than 80%, preferably less than 65%, more preferably less than 50% of the total surface area observed (surface area between the pores, surface area of said macropores and surface area of other pores).

In particular, said seal may extend between two faces of the seal that are facing and substantially parallel, preferably substantially planar.

As can be seen in more detail in the description below, said set cement has good adhesion and produces an assembled ceramic body with good mechanical strength, in particular in an application to filtering exhaust gas from automotive vehicles.

The blocks may in particular be porous blocks, and especially filter blocks for filtering exhaust gas from automotive vehicles. The set cement is particularly suitable for assemblies of filter blocks including asymmetrical channels.

Said section plane does not necessarily allows the largest section of each of the pores to be observed. Thus, certain pores are not counted among the macropores, although they would be counted in another section plane, and vice versa.

An assembled body in accordance with the invention may also comprise one or more of the following optional characteristics:
the set cement preferably comprises less than 10%, preferably less than 9.9%, preferably less than 9%, preferably less than 5%, preferably less than 3%, preferably less than 1%, preferably less than 0.5%, preferably less than 0.1% of inorganic fibers, in particular ceramic fibers, as a percentage by weight based on the dry mineral matter. Preferably, the set cement does not contain such fibers. The inventors have noticed that the performance of set cement is not significantly affected by the presence of a reduced quantity of inorganic fibers, in particular ceramic fibers;
the set cement has not undergone a debinding operation. It includes a quantity of organic fiber that is more than 0.1%, preferably more than 2%, more preferably more than 3% and/or less than 10%, preferably less than 5%, preferably less than 4%, as percentages by weight based on the dry mineral matter;
at least 80%, or even at least 90%, or even substantially 100% by number of the macropores result from an interconnection of the cells of a foam;
the pore size distribution in said section plane comprises a first mode centered upon a size in the range 500 μm to 5 mm and a second mode centered upon a size in the range 1 μm to 50 μm. This distribution may be such that said first and second modes are the main modes;
more than 50%, or even more than 70% by number of said macropores have a shape such that in said section plane, the ratio between their length and their width is more than 2;
in said seal, the macropores extend substantially parallel to the faces of the blocks between which said seal is disposed;
more than 50%, more than 60%, or even more than 80% by number of the macropores extend in said section plane substantially along the entire thickness of the seal, a thickness of set cement of at least 50 μm preferably being disposed between said macropores and said blocks (i.e. between any one of said macropores and the closest face of the seal);
preferably, in said section plane, more than 50%, more than 60%, or even more than 80% or even substantially 100% by number of the macropores have a width less than or equal to the local thickness of the seal minus 100 μm;
preferably, more than 50%, more than 60%, or even more than 80% or even substantially 100% by number of the macropores have, in said section plane, a width of more than 100 μm, preferably more than 300 μm, or even more than 400 μm, still more preferably more than 500 μm or more than 800 μm;
preferably, more than 50%, more than 60%, or even more than 80%, or even substantially 100% by number of the macropores have, in said section plane, a length less than or equal to 30 mm, preferably less than 15 mm, and/or greater than or equal to 500 μm, preferably greater than or equal to 1 mm, or even greater than or equal to 2 mm, more preferably greater than or equal to 5 mm;
the set cement comprises more than 5% of inorganic hollow spheres, as a percentage relative to the weight of the mineral matter;
the distribution of the inorganic hollow spheres falls into the following two fractions, for a total of 100% by weight:
   a fraction representing in the range 60% to 80% by weight of the inorganic hollow spheres and having a median dimension of more than 110 μm and less than 150 μm; and
   a fraction representing in the range 20% to 40% by weight of the inorganic hollow spheres and having a median dimension of more than 35 μm and less than 55 μm;
the total porosity of the set cement is more than 10% and less than 90%, preferably more than 30% and less than 85%;
the set cement includes more than 0.05% and less than 5% of a thermoset resin, as percentages relative to the weight of the dry mineral matter;
the set cement has a calcium oxide, CaO, content of less than 0.5%, and/or comprises more than 50% of silicon carbide, as a percentage by weight relative to the dry mineral matter;
silicon carbide (SiC), alumina (Al₂O₃), zirconia (ZrO₂), and silica (SiO₂) represent more than 85% of the weight of the dry mineral matter of the set cement;
the silicon carbide is present in the form of particles with a median dimension of less than 200 μm;
the set cement has, as a percentage by weight relative to the dry mineral matter, at least 5% of refractory particles, in particular particles of SiC, having a size in the range 0.1 μm to 10 μm, preferably in the range 0.3 μm to 5 μm;
preferably, more than 50%, or even more than 70%, or even more than 80% by number of the macropores have, in said section plane, an equivalent diameter in the range 500 μm to 5 mm;
preferably, more than 20%, or even more than 30% by number of the macropores have, in said section plane, an equivalent diameter in the range 5 mm to 10 mm;
preferably, more than 5%, preferably more than 10% by number of the macropores have, in said section plane, an equivalent diameter of more than 10 mm;
preferably, more than 5%, preferably more than 10% by number of the macropores are pores that have an actual length and/or an actual width, preferably an actual length and an actual width, of more than two times, or even more than three times, or even more than four times their actual thickness;
preferably, in said section plane, the set cement has pores having an equivalent diameter in the range 200 μm to 20 mm such that the total surface area occupied by said pores in said section plane represents more than 15%, preferably more than 20% and, preferably, less than 80%, preferably less than 65%, more preferably less than 50% of the total surface area observed;
the thickness of the seal is substantially constant;
the filter blocks comprise imbricated assemblies of adjacent inlet channels and outlet channels, preferably substantially rectilinear and/or parallel, disposed in a honeycomb. Preferably, the inlet and outlet channels alternate in order to form a checkerboard pattern in section;
the blocks include inlet channels and outlet channels, the overall volume of said inlet channels being greater than that of said outlet channels;
the filter blocks are porous ceramic blocks having more than 30%, or even more than 40% and/or less than 65%, or even less than 50% open porosity;
said blocks are not assembled using a continuous seal. In other words, there are regions between said blocks that are free of ceramic seal layer, said regions possibly being occupied by air or optional spacers that do not have to be attached to the blocks; and
said blocks are assembled by means of a seal that is not bonded to the faces of the seal over its entire contact surface with said seal faces, or that is bonded to said seal faces with an adhesive force that varies as a function of the zone under consideration.

Preferably, said set cement, in particular the set cement of said seal, has macropores in said quantity irrespective of said section plane perpendicular to at least one of the facing faces of the blocks assembled by said seal under consideration. In one embodiment, said section plane is a transverse median plane and/or longitudinal median plane of the seal.

Preferably, said set cement, in particular the set cement of said seal, has macropores in said quantity in a transverse median section plane and/or in a longitudinal median section plane of the seal. Preferably, said set cement, in particular the set cement of said seal, has macropores in said quantity both in a transverse median section plane and in a longitudinal median section plane of the seal.

Preferably, said set cement of said peripheral coating has macropores in said quantity in a section plane perpendicular to the longitudinal axis of the body, in particular at the mid-length of the body and/or in a section plane extending substantially radially (i.e. including the longitudinal axis of the body).

In accordance with a second main embodiment, the invention provides an assembled ceramic body, in particular an assembled filter body, comprising blocks attached to each other by means of a seal, the lateral surface of the ceramic body possibly being coated with a peripheral coating, the seal and/or the peripheral coating comprising, preferably being constituted by, a set cement, said set cement, in particular the set cement of said seal, in a transverse median section plane and/or in a longitudinal median section plane of the seal, preferably both in a transverse median section plane and in a longitudinal median section plane of the seal, having pores with an equivalent diameter in the range 200 μm to 40 mm in a quantity such that, in said section planes, the total surface area occupied by said pores represents more than 15%, preferably more than 20%, and preferably less than 80%, preferably less than 65%, more preferably less than 50% of the total surface area observed.

An assembled ceramic body in accordance with a second main embodiment may also comprise one or more of the characteristics, which may be optional, of a ceramic body in accordance with the first main embodiment, the characteristics relating to the macropores of the first main embodiment applying to said pores having an equivalent diameter in the range 200 μm to 40 mm of the second main embodiment.

In particular, preferably more than 50% by number of said pores have an equivalent diameter in the range 500 μm to 5 mm in said section plane.

In accordance with a third main embodiment, the invention provides an assembled ceramic body, in particular an assembled filter body, comprising blocks attached to each other by means of a seal, the lateral surface of the ceramic body possibly being coated with a peripheral coating, the seal and/or the peripheral coating comprising, preferably being constituted by, a set cement having more than 5%, preferably more than 10% by number of pores, termed “flattened pores”, having an actual length and/or an actual width, preferably an actual length and an actual width, of more than two times, or even more than three times, or even more than four times their actual thickness.

Preferably, more than 50%, more than 60%, or even more than 80%, or even substantially 100% by number of the flattened pores have an actual length less than or equal to 30 mm, preferably less than 15 mm, and/or greater than or equal to 500 μm, preferably greater than or equal to 1 mm, or even greater than or equal to 2 mm, more preferably greater than or equal to 5 mm.

Preferably more than 50%, more than 60%, or even more than 80%, or even substantially 100% by number of the flattened pores have an actual thickness of more than 100 μm, preferably more than 300 μm, or even more than 400 μm, still more preferably more than 500 μm or more than 800 μm.

The flattened pores, in particular the flattened pores of the set cement of said seal, preferably have an equivalent diameter in the range 200 μm to 40 mm in a transverse median section plane and/or in a longitudinal median section plane of the seal, preferably both in a transverse median section plane and in a longitudinal median section plane of the seal.

Preferably, in a transverse median section plane and/or in a longitudinal median section plane of the seal, the total surface area occupied by said flattened pores, in particular by the flattened pores of the set cement of said seal, represents more than 15%, preferably more than 20%, and, preferably, less than 80%, preferably less than 65%, more preferably less than 50% of the total surface area observed.

Preferably, more than 50% by number of said flattened pores have an equivalent diameter in the range 500 μm to 5 mm in said section plane.

Preferably, more than 50%, more than 60%, or even more than 80% by number of the flattened pores of the set cement of said seal extend substantially along the entire thickness of the seal, a thickness of set cement of at least 50 μm preferably being disposed between said flattened pores and said blocks (i.e. between any one of said flattened pores and the closest face of the seal).

An assembled ceramic body in accordance with a third main embodiment may also comprise one or more of the characteristics, possibly optional, of a ceramic body in accordance with the other main embodiments, the characteristics relating to the macropores of the first main embodiment applying to said flattened pores.

The invention also provides said set cement per se, irrespective of the embodiment under consideration. This cement is below termed the “set cement in accordance with the invention”.

Preferably, all of the seals of an assembled body in accordance with the invention are formed from a set cement in accordance with the invention.

The invention also provides a particulate mixture and a fresh cement that are capable of producing a set cement in accordance with the invention.

Finally, the invention provides a method for producing an assembled ceramic body, in particular an assembled filter body, comprising the following steps in succession:

a) preparing a fresh cement from a starting charge;

b) interposing said fresh cement between blocks to be assembled;

c) setting said fresh cement, optionally employing a heat treatment, in order to obtain a set cement in accordance with the invention.

The inventors have discovered several ways of obtaining a sufficient quantity of macropores in the set cement. In particular, it is possible to add organic fibers to the starting charge, then optionally to eliminate them by heat treatment after setting the cement.

Alternatively or in a complementary manner, it is possible to cause a gas to penetrate into the fresh cement prepared in step a), in particular by blowing in that gas, preferably at a plurality of injection points distributed in the fresh cement.

In one implementation, in step a) a fresh cement is prepared in the form of a foam. Adding a foaming agent to the starting feed is then preferable.

Adding a pore-forming agent may also be advantageous.

Finally, the inventors have discovered that adding inorganic hollow spheres also facilitates the creation of macropores.

Preferably, the addition of inorganic hollow spheres results from adding:
a first powder of hollow spheres representing in the range 60% to 80% by weight of the total of the inorganic hollow spheres and having a median dimension of more than 110 μm and less than 150 μm; and
a second powder of hollow spheres representing in the range 20% to 40% by weight of the total of the inorganic hollow spheres and having a median dimension of more than 35 μm and less than 55 μm.

Preferably, said first and second powders together represent substantially 100% of the added inorganic hollow spheres.

In one embodiment, the blocks to be assembled are immobilized during step c).

### DEFINITIONS

Conventionally, the term “seal” is applied to a continuous mass of refractory cement(s), i.e. not interrupted or discontinuous, extending between two faces of the seal facing two adjacent filter blocks.

The “longitudinal” direction of an assembled filter body is defined as the general direction of flow of the fluid to be filtered through said body. The longitudinal axis of a filter body or of a seal is the axis passing through the center of said filter body or said seal and extending along the longitudinal direction. A “longitudinal” plane is a plane parallel to the longitudinal direction. A “median” longitudinal plane is a longitudinal plane extending along the thickness of the seal under consideration (i.e. substantially perpendicular to the general plane in which the seal extends) and including the longitudinal axis of the seal.

A “transverse” plane is a plane perpendicular to the longitudinal direction. A “median” transverse plane is a transverse plane intersecting the seal under consideration substantially at the mid length of that seal.

In general, the blocks are assembled such that the facing faces of the seal are at least locally substantially parallel. In a honeycomb block, the channels conventionally extend parallel to each other, parallel to the lateral faces of the block, along the longitudinal axis of the block. A transverse plane is then substantially perpendicular to the facing faces of the blocks assembled by a seal (“seal faces”). Other dispositions of the channels may be envisaged, however.

For a rectangular parallelepipedal seal 27 with a longitudinal axis X, FIG. 8 illustrates the positioning of the median transverse plane “Pt” and the median longitudinal plane “Pl”.

The “equivalent diameter” of a pore in a section plane of a set cement is the diameter of a disk the surface area of which is equal to the surface area of the opening of that pore measured on said section of set cement, for example on a photograph of said section taken with an optical microscope. As an example, FIG. 7 shows a pore P as it appears in sectional view. In this sectional view, the pore has an area A. This area is the same as that of the disk D with diameter “d”. The equivalent diameter of the pore P, in this section, is thus “d”.

The length of a pore in a section plane is its largest dimension in that section plane. The width of a pore in a section plane is its largest measured dimension in that section plane perpendicular to the direction of its length.

The actual length of a pore is its largest dimension. The actual width of a pore is its largest dimension measured perpendicular to the direction of its actual length. The actual thickness of a pore is its largest dimension measured perpendicular to the directions of its actual length and its actual width.

The “equivalent diameter” of a fiber is the diameter of a disk having a surface area that is equal to the surface area of the largest section of that fiber, perpendicular to the length of that fiber.

A “particulate mixture” is a mixture of particles, dry or wet, suitable for setting following activation.

The particulate mixture is said to be “activated” when it undergoes a setting process. The activated state conventionally results from moistening with water or another liquid. An activated particulate mixture is termed “fresh cement”. Coagulation (setting) may result from drying or, for example, curing of a resin. Finally, heating can accelerate the evaporation of water or residual liquid after setting.

The solid mass obtained by setting a fresh cement is termed “set cement”.

The term “temporary” means “eliminated from the product by the heat treatment”.

The term “sphere” means a particle having a sphericity, i.e. a ratio between its smallest diameter and its largest diameter, of 0.75 or more, irrespective of the manner in which that sphericity has been obtained. A sphere is termed “hollow” when it has a central cavity, closed off or open to the outside, the volume of which represents more than 50% of the overall external volume of the hollow sphere.

The term “size” of a sphere or of a particle is its largest dimension.

Conventionally, the term “median dimension” or “median diameter” or “d50” is given to a mixture of particles or a set of grains, the size dividing the particles of that mixture or the grains of that set into first and second populations that are equal in number, said first and second populations comprising only particles or grains having a size respectively greater than or less than the median dimension.

The term “thermoset resin” means a polymer that can be transformed into a material that is non-fusible and insoluble following heat treatment (heat, radiation) or physico-chemical treatment (catalysis, curing agent). Thermoset resins thus take on their definitive form when the resin first cools; it is impossible to reverse, in particular under the conditions of service and regeneration of filter bodies employed in automotive vehicles.

A “fused” product is a product obtained by a method comprising melting starting materials, in particular by electrofusion, then solidification by cooling the molten liquid.

Unless otherwise indicated, the term “comprising a” should be understood to mean “comprising at least one”.

### BRIEF DESCRIPTION OF THE FIGURES

Other characteristics and advantages of the invention become apparent from the following detailed description and an examination of the accompanying drawing in which:

FIGS. 1 and 2 diagrammatically show a filter body in section along the plane B-B and in section along the plane A-A respectively;

FIGS. 3 and 4 are photographs of cross-sections and longitudinal sections respectively of a detail of a filter body including a seal formed from a set cement in accordance with Example 1 described below;

FIG. 5 is a photograph of a cross-section of a detail of a filter body comprising a seal formed from a set cement in accordance with Example 2 described below;

FIG. 6 shows the result of processing the photograph of FIG. 5 in order to determine the surface area occupied by the macropores;

FIG. 7 is an image of a pore intended to illustrate the definition of an equivalent diameter; and

FIG. 8 shows, for a rectangular parallelepipedal seal, the positioning of the transverse median and longitudinal median planes.

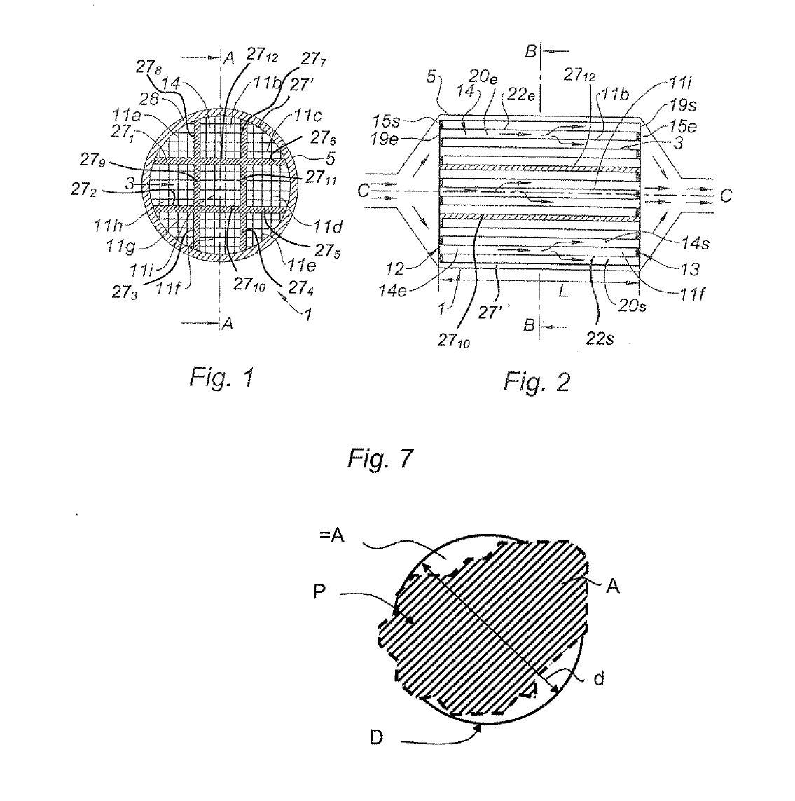

### DETAILED DESCRIPTION

An assembled body in accordance with the invention may be produced using a method in accordance with steps a) to c) below.

In step a), a fresh cement in accordance with the invention may be prepared using conventional methods by activating a particulate mixture in accordance with the invention.

As described below, a particulate mixture in accordance with the invention may in particular comprise refractory powders, organic fibers, inorganic hollow spheres, a thermoset resin, pore-forming agents, a dispersant, and shaping and sintering additives. In one embodiment, the particulate mixture does not include other constituents.

In the present description and claims, the term “refractory powders” is distinguished from the term “inorganic hollow spheres”. Unless otherwise indicated, the characteristics concerning the refractory powders are thus determined without considering the inorganic hollow spheres.

Any of the refractory powders conventionally used for the production of set cements intended for refractory ceramic seals for assembling filter blocks may be used.

The refractory powders may in particular be powders based on silicon carbide and/or alumina and/or zirconia and/or silica.

Preferably, the refractory powders are fused products. The use of sintered products is also possible.

Preferably, the refractory powders represent more than 50%, preferably more than 70% of the weight of the dry mineral matter of the particulate mixture.

In one embodiment, the silicon carbide, zirconia, alumina, silica and combinations of said compounds, for example mullite or mullite-zirconia, together represent more than 80%, preferably more than 95% of the weight of the dry mineral matter.

Preferably, the particulate mixture, apart from the inorganic hollow spheres, comprises:
more than 10%, or even more than 30%, or even more than 65%, or even better more than 80% and/or less than 90% of silicon carbide;
in the range 1% to 50% of alumina; and
in the range 1% to 50% of silica;
   as percentages by weight relative to the dry mineral matter, and preferably for a total of approximately 100%. These ranges for the alumina and silica make it easier to use and increase the mechanical strength following sintering. This silicon carbide range ensures good chemical resistance, rigidity while hot, and thermal conductivity of the set cement.

Preferably, the refractory powders used have a median dimension of more than 20 μm, preferably more than 45 μm, more preferably more than 60 μm and/or less than 200 μm, less than 150 μm, preferably less than 120 μm, more preferably less than 100 μm.

Preferably, however, the particulate mixture is supplemented with more than 5%, or even more than 10% and/or less than 50%, or even less than 20%, as percentages by weight relative to the dry mineral matter, of a refractory powder having a median diameter of less than 5 μm, preferably less than 1 μm. This means that the cohesion of the fresh cement is improved following drying.

Preferably, the particulate mixture comprises organic fibers that are optionally eliminated during debinding.

The quantity of organic fibers in the particulate mixture is preferably more than 0.1%, preferably more than 2%, more preferably more than 3% and/or less than 10%, preferably less than 5%, preferably less than 4%, as percentages by weight based on the dry mineral matter of the particulate mixture.

The organic fibers may in particular be selected from the group formed by synthetic organic fibers such as acrylic fibers or polyethylene fibers, and natural fibers, such as wood or cellulose fibers.

Preferably, the organic fibers are not hydrosoluble, such that they can be present in the set cement before the optional heat treatment in step c).

In a preferred embodiment, the organic fibers are cellulose fibers. Advantageously, the use of said fibers limits toxic emanations during their elimination.

The mean length of the organic fibers is preferably more than 0.03 mm, preferably more than 0.1 mm and/or less than 20 mm, preferably less than 10 mm.

Preferably, the mean equivalent diameter of the organic fibers is more than 5 μm, preferably more than 10 μm, more preferably more than 20 μm, and/or less than 200 μm, preferably less than 100 μm, preferably less than 50 μm, still more preferably less than 40 μm.

Adding organic fibers is particularly advantageous. Said fibers may be eliminated by heat treatment, thereby leaving a place for the pores. It is then easy to control the pore size and their distribution in the set cement.

Furthermore, the use of organic fibers contributes to the formation of macropores by retaining and by agglomerating the particles during migration of the water that is produced following application of fresh cement to the surfaces of the blocks. This agglomeration also results in the formation of elongate pores. The theory for the mechanism for the formation of these macropores has not, however, been explained by the inventors.

The presence of inorganic hollow spheres in the particulate mixture also contributes to the creation of macropores, and again the mechanism is not explained. Simply adding inorganic hollow spheres such as those described below is not sufficient to create macropores in accordance with the invention.

Preferably, the particulate mixture comprises more than 3%, preferably at least 5%, and/or, preferably, less than 50%, more preferably less than 30% of inorganic hollow spheres, as percentages by weight based on the dry mineral matter.

Preferably, the inorganic hollow spheres are spheres obtained by a method comprising a step of fusion or combustion of starting materials, for example fly ash from metallurgical processes, then, in general, a condensation step.

The inorganic hollow spheres preferably have the following chemical composition as a percentage by weight, and for a total of at least 99%: in the range 20% to 99% of silica (SiO₂) and in the range 1% to 80% of alumina (Al₂O₃), the remainder being constituted by impurities, in particular iron oxide (Fe₂O₃) or oxides of alkali or alkaline-earth metals.

Examples of inorganic hollow spheres that may be used are those supplied by Enviro-spheres under the trade name “e-spheres”. They typically comprise 60% silica, SiO₂, and 40% alumina, Al₂O₃, and are conventionally used to improve the rheology of paints or concrete in civil engineering applications, or to constitute a mineral filler in order to reduce the cost of plastics products.

Preferably the inorganic hollow spheres have a sphericity that is greater than or equal to 0.8, preferably greater than or equal to 0.9. More preferably, more than 80%, preferably more than 90% by number of the inorganic hollow spheres are closed.

The walls of the inorganic hollow spheres are preferably dense or of low porosity. Preferably, they have a density of more than 90% of their theoretical density.

In one embodiment, the median dimension of the population of inorganic hollow spheres is more than 80 μm, preferably more than 100 μm and/or less than 160 μm, more preferably less than 140 μm. More preferably, the median dimension of the inorganic hollow spheres is approximately 120 μm.

In a preferred embodiment, the distribution of the inorganic hollow spheres falls into the following two fractions, for a total of 100% by weight:
a fraction representing in the range 60% to 80%, preferably approximately 70% by weight of the inorganic hollow spheres and having a median dimension of more than 110 μm, preferably more than 120 μm, and/or less than 150 μm, preferably less than 140 μm, preferably approximately 130 μm; and
a fraction representing in the range 20% to 40%, preferably approximately 30% by weight of the inorganic hollow spheres and having a median dimension of more than 35 μm, preferably more than 40 μm, and/or less than 55 μm, preferably less than 50 μm, preferably approximately 45 μm.

The particulate mixture may also comprise more than 0.05%, preferably more than 0.1%, more preferably more than 0.2%, and/or less than 5% of a thermoset resin, as percentages by weight relative to the dry mineral matter.

The thermoset resin is preferably selected from epoxy, silicone, polyimide, phenolic, and polyester resins.

Preferably, the thermoset resin is soluble in water at ambient temperature.

Preferably, at least after activation of the particulate mixture, the thermoset resin has a tacky nature before it is cured. Thus, positioning of the fresh cement is facilitated and it holds its shape before the heat treatment. It preferably has a viscosity of less than 50 pascal-seconds (Pa·s) for a shear gradient of 12 per second (s⁻¹) measured using a Haake VT550 viscosimeter.

Depending on the applications, it may be advantageous for the resin to be selected such that it cures at ambient temperature, for example following addition of a catalyst, at the drying temperature or at the heat treatment temperature.

Advantageously, the presence of thermoset resin improves the mechanical strength of the set cement, in particular when cold.

A thermoset resin also improves the mechanical strength of the assembled body, which is useful when manipulating the body, and is of particular advantage when canning.

In a preferred embodiment, any thermoset resin used is dissolved to reduce its viscosity, for example with water, before adding it.

A catalyst for the resin may also be added in order to accelerate setting of the resin. The catalysts, for example furfuryl alcohol or urea, are selected as a function of the type of resin and are well known to the skilled person.

A pore-forming agent, for example selected from cellulose derivatives, acrylic particles, graphite particles, and mixtures thereof, may also be incorporated into a particulate mixture in accordance with the invention in order to create the pores.

Simply adding currently known pore-forming agents is not sufficient, however, to create the macroporosity necessary to obtain an assembled body in accordance with the invention.

The porosity created by adding conventional current pore-forming agents is generally dispersed in a heterogeneous manner in the cement. Further, in a section plane perpendicular to at least one of the facing faces of the blocks assembled by a seal, the equivalent diameter of pores due to the pore-forming agents is in general less than 200 μm.

The inventors have also established that an increase in the quantity of pore-forming agents or in the diameter of the particles of pore-forming agent powders may result in an increase in the diameter of the pores that are generated, and may also result in a deterioration in the mechanical properties of the seal, which is particularly prejudicial to manipulation of the assembled body. Adding more than 10% of pore-forming agents, by volume relative to the volume of the dry particulate mixture, is thus considered to be counter-productive.

In order to produce a fresh cement in the form of a foam, it is preferable to add to the particulate mixture in the range 0.5% to 10%, as percentages by weight relative to the dry mineral matter, of a compatible foaming agent such as a soap or a soap derivative.

It is possible to add more than 1%, more than 2% and/or less than 8%, less than 6%, or less than 5% of a foaming agent, as percentages by weight relative to the dry mineral matter.

Preferably, the foaming agent is temporary. Preferably, it is selected from ammonium derivatives, for example an ammonium bicarbonate, preferably an ammonium sulfate or an ammonium carbonate, an amyl acetate, a butyl acetate, or a diazoaminobenzene.

Preferably, the particulate mixture is further supplemented with in the range 0.05% to 5% of a gelling agent, as percentages by weight relative to the dry mineral matter, such as a hydrocolloid of animal or vegetable origin that can form a gel in a thermoreversible manner following foaming. Examples of gelling agents that may be mentioned are xanthan and the carrageen.

It is possible to add more than 0.1%, more than 0.15% and/or less than 3%, less than 2%, less than 1%, or even less than 0.8% of a gelling agent, as percentages by weight relative to the dry mineral matter.

Foaming agents and gelling agents that may be used are described, for example, in FR 2 873 686 or EP 1 329 439. According to those documents, a stabilizing agent may also be added.

Adding both a foaming agent and a gelling agent increases the interconnection between the cells.

The particulate mixture may comprise in the range 0.1% to 2%, preferably in the range 0.1% to 0.5%, preferably less than 0.5% by weight of a dispersant, as percentages by weight relative to the dry mineral matter.

The dispersant may, for example, be selected from polyphosphates of alkali metals or methacrylate derivatives. Any known dispersing agent may be envisaged: solely ionic, for example HMPNa, solely steric, for example of the sodium polymethacrylate type, or both ionic and steric. Adding a dispersant means that fine particles with a dimension of less than 50 μm are better distributed, thereby aiding the mechanical strength of the set cement.

In addition to the constituents mentioned above, the particulate mixture may also comprise one or more shaping or sintering additives in routine use, in proportions that are well known to the skilled person.

Non-limiting examples of additives that may be used that may be mentioned are:
temporary organic binders such as resins, cellulose or lignone derivatives such as carboxymethylcellulose, dextrin, polyvinyl alcohols, polyethylene glycols or other chemical setting agents such as phosphoric acid or sodium silicate;
inorganic binders such as silica gels or silica in the colloidal form;
chemical setting agents, such as phosphoric acid, aluminum monophosphate, etc.;
sintering promoters such as titanium dioxide or magnesium hydroxide;
shaping agents such as magnesium or calcium stearates.

The particulate mixture may in particular comprise in the range 5% to 20% of a silica and/or alumina and/or zirconia sol, as percentages by weight relative to the mineral matter, said sol comprising 20 to 60% by weight of colloids.

In one embodiment, the particulate mixture includes no microcapsules of resin enclosing a gas such as CO₂.

The shaping or sintering additives are incorporated in varying proportions that are, however, sufficiently low not to substantially modify the proportions by weight of the various constituents of the set cement after debinding.

The various constituents of the particulate mixture are preferably mixed to homogenization, for example in a planetary type mixer, intensive or otherwise.

Preferably, the particulate mixture in accordance with the invention is dry. Even if this embodiment is not preferred, certain of the constituents mentioned above, in particular the thermoset resin or the dispersant, may, however, be added in the liquid form. The invention also provides such a moist particulate mixture.

Conventionally, water is added to the particulate mixture in order to activate it and obtain a fresh cement in accordance with the invention.

Preferably, the fresh cement has a water content of less than 40% as a percentage by weight relative to the dry matter (mineral or not).

More preferably, the organic fibers are added after the other constituents, including the water, have been mixed with one another.

As an alternative to adding organic fibers, or as a complement to adding organic fibers, it is possible to foam the fresh cement in order to create the macropores.

Examples of methods for foaming with gelling that may be used for this purpose are described in FR 2 873 686 or EP 1 329 439.

Preferably, the powders are added while the mixer is rotating followed, if appropriate, by the foaming agent.

In order to foam a fresh cement in accordance with the invention, intensive mixing may in particular be employed by creating a vortex that favors the ingress of gas, in particular air, into the fresh cement; and/or gas may be blown in.

The efficiency of the intensive mixing may be modified by changing the rate of rotation, the dimensions and the shape of the mixer blade and the diameter of the blade relative to the diameter of the mixer. Mixing may be carried out at atmospheric pressure.

Blowing in a gas can control the macroporosity in a particularly accurate manner. Blowing in a gas, in particular air, also means that other types of porosity, other than macroporosity, can be created. Further adding a foaming agent becomes advantageously optional.

The gas may be injected using a suitable mixer. Preferably, the gas is blown in via a plurality of injection points distributed such that the pores are distributed in a substantially uniform manner in the fresh cement. Preferably, the gas is blown through orifices with a diameter of more than 0.05 mm and/or less than 5 mm. The diameter of the gas bubbles thus generally remains below 200 μm. More preferably, the gas is blown in during the mixing or homogenizing phase following addition of water.

Preferably, more than 0.5, preferably more than 0.7, preferably more than 1 liter of gas per liter of fresh cement and/or less than 2.5, preferably less than 2.0, more preferably less than 1.8 liter of gas per liter of fresh cement, is injected. The pressure of injection, which is preferably constant, is not a determining factor.

When producing a foam, the choice of the grain size of the particles of the particulate mixture means that the structural cohesion of the foam can be adjusted before application as a ceramic seal layer.

In step b), the fresh cement is interposed between the blocks to be assembled, in particular between filter blocks, or at the periphery of a ready-assembled body.

Any blocks may be used. In particular, they may be porous ceramic blocks having more than 30%, or even more than 40% and/or less than 60%, or even less than 50% open porosity, in particular filter blocks such as those described in the introduction, the ceramic body then being a filter body.

Such blocks, intended to filter particles contained in the exhaust gas from an internal combustion engine, in particular a diesel engine, comprise imbricated series of adjacent inlet channels and outlet channels, preferably substantially rectilinear, in a honeycomb disposition. Preferably, the inlet and outlet channels alternate in order to form a checkerboard pattern in section.

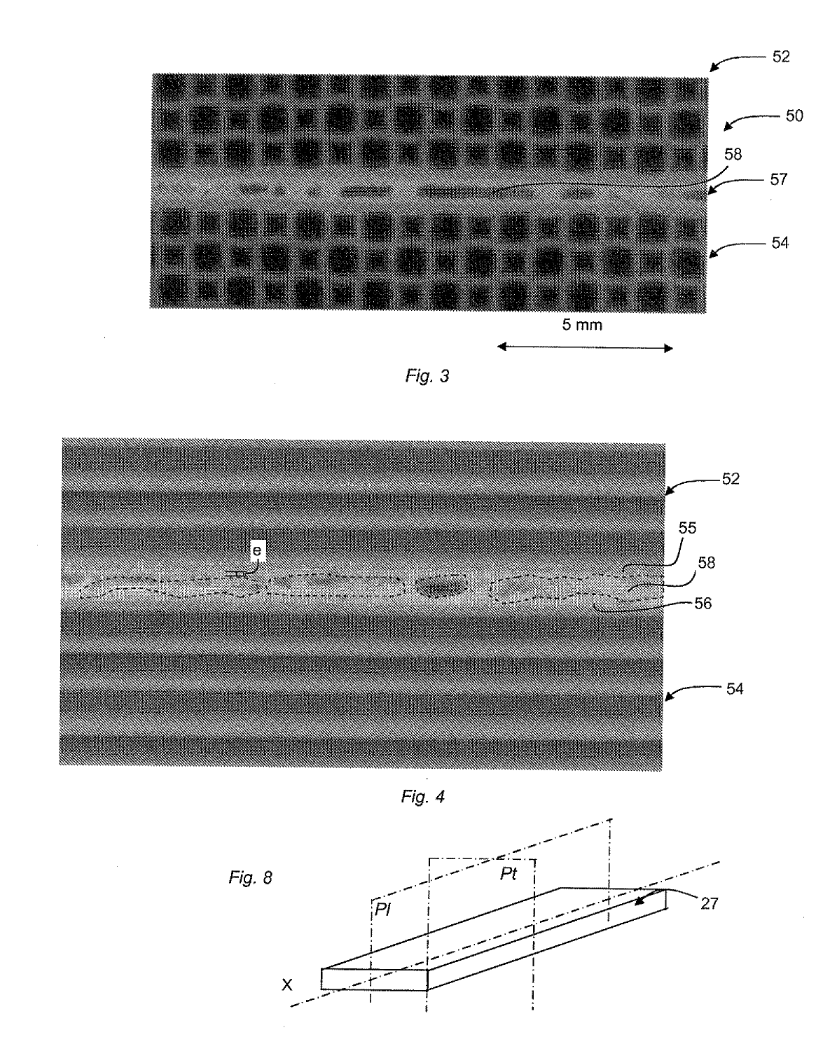

Preferably, the overall volume of said inlet channels is more than that of said outlet channels. The intermediate walls separating two horizontal or vertical rows of channels may in particular have an undulating shape in cross-section, for example a sinusoidal shape, such as in FIGS. 3 and 6. Preferably, as in the figures, the width of a channel is substantially equal to the half period of the sinusoid wave.

Preferably, the blocks are formed from a sintered material and comprise more than 50%, or even more than 80% by weight of re-crystallized silicon carbide, SiC, and/or of alumina titanate and/or mullite and/or cordierite and/or silicon nitride and/or sintered metals.

The fresh cement may be applied to the surface of the blocks to be assembled in a continuous manner, i.e. over the whole surface of the facing faces of the blocks.

In a preferred embodiment however, the fresh cement covers only a portion, between 10% and 90%, of said surface. The seal between two blocks is thus interrupted. Between the blobs of fresh cement, spacers may be disposed in order to ensure a predetermined distance between the two blocks.

In one embodiment, the fresh cement is applied in a discontinuous manner in order to form a plurality of locally adapted seal portions in order to optimize weakening of the thermo-mechanical stresses that are likely to be generated.

The following particular adaptations are possible:
at least two of said seal portions comprise materials that differ in their composition and/or their structure and/or their thickness;
the cements of said seal portions have elastic moduluses that differ by a value greater than or equal to 10%;
at least one of said seal portions has anisotropic elastic properties;
said seal portion comprises silica impregnated with a cement;
the thicknesses of at least two of said seal portions differ by a ratio of at least two;
at least one of said seal portions comprises an aperture;
said aperture opens onto one of the upstream and downstream faces of said body;
said aperture is formed in a plane substantially parallel to the faces of said blocks assembled by said seal portion (“seal faces”);
the length or depth of said aperture is in the range 0.1 and 0.9 times the total length of said body;
said aperture is substantially adjacent to one side of said blocks;
said aperture is filled, at least in part, with a filling material that adheres neither to said block nor to the cement of said seal portion in which it is arranged; and
said filling material is boron nitride or silica.

FR 2 833 857 describes a method for producing said seals.

The fresh cement may be disposed such that the set cement obtained adheres with the same force on the two faces of the seal for the blocks that it binds or with a variable adhesive force in the same seal face.

In one embodiment, the fresh cement is applied such that the first face of the seal comprises at least one first region of strong adhesion with the seal and a region of weak or zero adhesion with said seal, said regions preferably being respectively disposed facing a first region of weak or zero adhesion of the second face of the seal, and a region of strong adhesion of the second face with said seal. The first face of the seal may also comprise a second region of strong adhesion with the seal disposed facing a second region of weak or zero adhesion of the second face of the seal. FR 2 853 255 describes a method for producing such seals.

The blocks are then united using fresh cement.

Preferably, the quantity of fresh cement is determined such that the thickness of the seal, preferably constant, is less than 4 mm, preferably less than 3 mm.

Once the fresh cement has been positioned, the organic fibers orientate themselves substantially parallel to the faces of the blocks between which the fresh cement has been disposed and create the macroporosity. It is thus possible to produce an assembled body in accordance with the invention before any operation for eliminating organic fibers.

In step c), the filter blocks are preferably held in position in order to prevent the fresh cement from expanding during setting, for example by pinning the blocks with spacers as described, for example, in EP 1 435 348, and banding the thus-pinned blocks.

Preferably, if a foaming agent and a gelling agent are present, the filter blocks are held in position when the gelling agent is xanthan, agarose, or another gelling agent acting as a thickening agent.

In one embodiment, the gelling agent is gelatin or another gelling agent that gels on cooling. Advantageously, swelling during drying is thus limited. Holding it in position is therefore no longer indispensable.

After being placed between the blocks, the fresh cement is dried, preferably at a temperature in the range 100° C. to 200° C., preferably in air or a moisture-controlled atmosphere, preferably with the residual moisture being in the range 0 to 20%.

In one embodiment, if a foaming agent and a gelling agent are present, the fresh cement is dried before the end of gelling, more preferably before the onset of gelling, or even without gelling. For example, for gelatin type gelling agents, drying may be carried out before the temperature drops below the gelling temperature.

Preferably, the drying period is in the range from a few seconds to 10 hours, in particular as a function of the format of the seal and of the assembled ceramic body. Drying accelerates polymerization of the thermoset resin and curing of the organic binder. A set cement in accordance with the invention is thus obtained.

The optional heat treatment is preferably carried out in an oxidizing atmosphere, preferably at atmospheric pressure, and preferably at a temperature in the range 400° C. to 1200° C.

It comprises debinding and/or firing.

Debinding is carried out at a temperature resulting in elimination of the organic components.

After drying, organic fibers may still be present. Debinding at a temperature sufficient to eliminate these fibers can thus advantageously create the porosity.

Firing is generally accompanied by an improvement in the mechanical strength.

The firing period, preferably in the range approximately 1 to 20 hours cold to cold, varies as a function of the materials but also as a function of the size and shape of the seals.

Firing may also be carried out in situ. In particular, for filter bodies intended for automotive vehicle filters, the filter bodies may be installed in an automotive vehicle before eliminating the organic fibers, the regeneration temperature being sufficient to eliminate them. As an example, the combustion temperature of cellulose fibers is approximately 200° C., while the regeneration temperature for filter bodies is typically approximately 500° C. or even higher.

After firing, an assembled body in accordance with the invention is obtained.

Details of an assembled body 50 are shown in FIGS. 3 to 5. This assembled body comprised blocks 52 and 54 in a honeycomb with an asymmetrical structure. These blocks are assembled by means of the two seal faces 55 and 56 of a seal 57 having macropores 58.

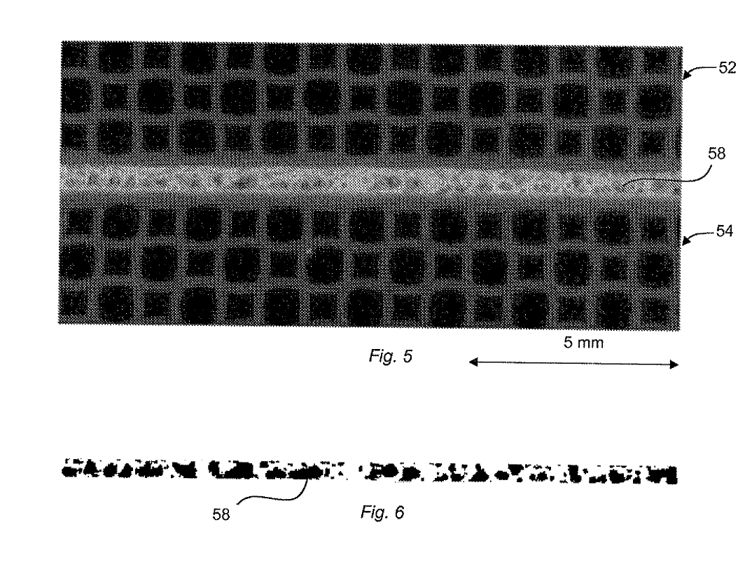

The macropores 58 may have a relatively regular shape, resembling flattened bubbles between the faces of the seal, as in FIGS. 3 and 4, or be highly irregular, when they are the result of foaming fresh cement in particular, as in FIG. 5. In this figure, the macropores result from interconnection of the cells of a foam.

The assembled body may then be machined and optionally coated with a peripheral ceramic coating as described, for example, in EP 1 142 619 or EP 1 632 657. Said peripheral coating may be produced from a fresh cement in accordance with the invention.

The assembled body may also undergo a complementary consolidation heat treatment or even sintering. The sintering temperature is preferably more than 1000° C., but must not result in degradation of the blocks.

The total porosity of the set cement may be more than 10%, preferably more than 30% and/or less than 90%, preferably less than 85%.

The pore size distribution may be multimodal, preferably bimodal. In particular, the set cement may comprise micropores with an equivalent diameter, in said section plane in which the quantity of the macropores is determined, typically of less than 50 μm.

Preferably, the pore size distribution comprises a first mode centered upon a size in the range 500 μm to 5 mm (macropores) and a second mode centered upon a size in the range 1 μm to 50 μm (micropores). This distribution may be such that said first and second modes are the main modes.

The presence of micropores improves the thermomechanical strength while increasing thermal insulation. The presence of micropores also contributes to the reduction in the density of the set cement and thus the mass of the body, which is particularly advantageous for applications in which the body is a filter body on board an automotive vehicle.

In said section plane in which the quantity of macropores is evaluated, the surface area of the micropores preferably, however, represents less than 20% of the total surface area.

The macropores may be interconnected, for example in a foam type structure. Such an interconnection is not, however, indispensible to the invention.

In one embodiment, more than 50%, preferably more than 80%, or even more than 90% by number of the macropores have an elongate shape, i.e. such that the ratio between their length and their width is more than 2, the length and the width being measured in said section plane in which the quantity of macropores is evaluated.

Preferably, more than 50%, preferably more than 80%, or even more than 90% by number of the macropores extend substantially parallel to the faces of the blocks between which the seal is disposed, as can be seen in FIG. 4. More preferably, more than 50%, preferably more than 80%, or even more than 90% by number of them extend substantially along the entire thickness of the seal. As can be seen in FIG. 4, they thereby define between them “bridges” of matter that connect the facing faces of the blocks. However, a thickness “e” of set cement of at least 50 μm separates the macropores of the faces of the seal.

Preferably, the set cement has a calcium oxide content (CaO) of less than 0.5%, as a percentage by weight. The weakening occasioned by the presence of CaO is thus advantageously limited. Preferably, the set cement does not include CaO, unless it is in the form of any impurities brought in by the starting materials. The lifetime of the set cement, in particular in the application to filter bodies, is thus increased. This improvement in mechanical strength also means that the ceramic fiber content can be limited or they may even be dispensed with, and/or the silicon carbide content can be increased.

### EXAMPLES

The following examples are provided by way of non-limiting illustration.

The upper portion of Table 1 provides the composition of the starting charges of the various set cements tested, as percentages by weight.

The following starting materials were used:
inorganic silica-alumina fibers: length<100 mm and shot<5%;
0-0.2 mm SiC powder having a SiC content of >98%, from Saint Gobain Materials;
SiC powder with a median diameter of approximately 60 μm having an SiC content of >98%, from Saint Gobain Materials;
SiC powder with a median diameter of approximately 30 μm having an SiC content of >98%, from Saint Gobain Materials;
DPF C SiC powder with a median diameter of approximately 10 μm and having an SiC content of >98%, from Saint Gobain Materials;
SiC powder with a median diameter of approximately 2.5 μm having an Sic content of >98%, from Saint Gobain Materials;
SiC powder with a median diameter of 0.3 μm;
electrofused mullite zirconia powder supplied by Treibacher, with a median diameter of approximately 40 μm;
electrofused mullite zirconia powder supplied by Treibacher, with a median diameter of approximately 120 μm (reference: “FZM 0-0.15”);
SLG hollow spheres with a median diameter of approximately 137 μm, supplied as E spheres by Envirospheres;
SLG 75 hollow spheres of approximately 40 μm, supplied as E spheres by Envirospheres;
CL370 calcined alumina supplied by Almatis;
971U fumed silica supplied by Elkem;
Kerphalite KF5 (d50: 5 μm) from Damrec;
cellulose organic fibers supplied by Rettenmaler Arbocel, grade B400 with length 900 μm, mean equivalent diameter 20 μm, and with density 20 to 40 g/liter;
sodium silicate powder dispersing agent;
sodium tripolyphosphate powder dispersing agent;
xanthan gum of the Satiaxane™ CX90T type supplied by SKW Biosystems;
organic binder derived from cellulose;
30% colloidal silica sol;
powdered epoxy resin;
catalyst for resin (liquid);
W53FL foaming agent dispersant based on ammonium acrylate, supplied by Zschimmer Schwarz GmbH.
   The activated particulate mixtures of the Examples Ref 1, Ref 2 and Example 1 were prepared in a non-intensive planetary type mixer using a conventional procedure comprising:
dry mixing the dry starting materials for 2 minutes; then
adding water, optionally with a binder (polysaccharide) and a catalyst if appropriate;
mixing for 5 to 10 minutes to obtain a sufficient consistency to form the seals.

The viscosity measured for the fresh cements thus obtained was typically in the range 5 mPa·s⁻¹ to 20 mPa·s⁻¹ and preferably in the range 10 mPa·s⁻¹ to 13 mPa·s⁻¹ for a shear gradient of 12 s⁻¹ measured using a Haake VT550 viscosimeter.

The references 1 and 2 (“Ref. 1”, “Ref. 2”) correspond to a fibrous set cement in accordance with Example 1 of EP 0 816 065 and to a set cement as described in FR 2 902 424.

Examples 2 and 3 were set foamed cements which had been prepared in a mixer adapted for foaming by blowing in gas, using the following procedure:
homogenizing a mixture of water+silica sol+resin catalyst+xanthan gum at a rotation rate of 500 rpm (revolutions per minute) for 15 minutes;
adding the other powders, maintaining the rotation at 500 rpm;
adding the foaming agent based on ammonium sulfate and mixing for 5 minutes;
injecting air in order to blow in a volume of 1.5 liters of air per liter of fresh cement, the speed of the mixer being reduced to 200 rpm until a homogeneous paste is obtained.

Examples 1 to 3 are set cements in accordance with the invention.

The open porosity was measured using mercury porosimetry.

Parallelepipedal filter blocks in routine use for the production of filter bodies and having the following external dimensions: 35.8×35.8×8.75 mm³ were assembled with the prepared fresh cements. In order to keep the thickness of the seal constant, 1 mm thick wedges or “spacers” were disposed between the faces of the seal of the filter blocks to be assembled.

Three filter blocks were assembled with one another in succession in this manner.

In Examples 2 and 3 (hardened foam cement), the three filter blocks were banded in order to limit or even stop expansion of the fresh cement during drying.

The body constituted by the three filter blocks was then dried in air at 100° C. for 1 hour.

In the particular case of Examples 1 to 3, the body was then fired at 1100° C. in air for 1 hour in order to provide sufficient cohesion for manipulation and machining.

Image analysis of photographs taken using the optical microscope on a cross-section of the seals (in a plane perpendicular to the direction of the channels, which extends parallel to the length of the blocks) allowed the surface area of the pores that appeared as macropores to be measured and allowed the ratio of the sum of the surface area of said macropores to the total observed surface area to be calculated.

The adhesive force of the ceramic seal layer was measured using the following adhesion test. The assembly was placed such that the two peripheral filter blocks were supported, the distance between the supports being 70 mm. The central filter block was subjected to pressure with a punch being moved at 0.5 millimeters per minute (mm/min). The force at which the central filter block was detached from the assembly was measured and the stress, in MPa, was calculated by dividing this force at break, expressed in N, by the product 2×35.8×75 mm². An adhesive resistance of 0.1 MPa or more was considered to be necessary to ensure sufficient cohesion of the assembly by the cement.

TABLE 1

| | Particulate mixtures | | | | |
|---|---|---|---|---|---|
| Percentages by weight | Ref. 1 | Ex. 1 | Ex. 2 | Ex. 3 | Ref. 2 |
| Silica-alumina fibers | 38.2 | | | | |
| 0-0.2 mm SiC powder | | | | | 29.3 |
| SiC powder, d50: 60 μm | | | | | 21.3 |
| SiC powder, d50: 30 μm | | | 55.5 | | |
| SiC powder, d50: 10 μm | | | | | 10.8 |
| SiC powder, d50: 2.5 μm | | 19.5 | 27.6 | 13.3 | 4.0 |
| SiC powder, d50: 0.3 μm | 49.5 | | | | |
| Mullite zirconia powder | | 39.1 | | | |
| D50 = 120 microns approx. | | | | | |
| Mullite zirconia powder; | | | | 72.7 | |
| D50 = 40 microns approx. | | | | | |
| SLG hollow spheres | | 5.6 | | | 16.6 |
| SLG 75 hollow spheres | | 2.6 | | | 6.9 |
| CL370 calcined alumina | | 2.6 | | | 3.0 |
| 971U fumed silica | | 11.2 | 1.7 | 1.8 | 5.9 |
| Kerphalite, KF5 | | 2.6 | | | |
| Organic fibers | | 3.4 | | | |
| Sodium silicate | | | 0.7 | | |
| Sodium tripolyphosphate | no | 0.2 | | | 0.1 |
| Gelling agent: Xanthan gum | | | 0.2 | 0.5 | |
| Organic binder | 0.8 | 1.1 | | | 0.3 |
| Colloid silica sol | 11.5 | 11.2 | 7.6 | 7.8 | |
| Epoxy resin | | 0.1 | 0.4 | | 0.2 |
| Catalyst | No | 0.8 | 2.6 | | 1.6 |
| Foaming agent | | | 3.7 | 3.9 | |
| Total | 100.0 | 100.0 | 100.0 | 100 | 100.0 |
| Water (as % of particulate | 63.9 | 55.5 | 13.4 | 23.2 | 36.2 |
| mixture) | | | | | |

Results

| | | | | | |
|---|---|---|---|---|---|
| % of surface occupied by | 13 | 23 | 48 | 45 | <10 |
| macropores | | | | | |
| Adhesion test (MPa) | 0.12 | 0.16 | 0.16 | 0.17 | 0.13 |
| Open porosity of fired | 38.0 | 47 | 80 | 81 | 30 |
| product | | | | | |

Table 1 shows that the set cements of the invention have highly satisfactory adhesive properties. Furthermore, their very high macroporosity, in particular for the set cements in accordance with Examples 2 and 3, provides them with advantageous thermal insulation properties in certain applications.

In particular, surprisingly, a good thermal insulation capacity is advantageous for filter bodies subjected to very severe thermomechanical stresses during spontaneous or poorly controlled regeneration phases.

Clearly, the present invention is not limited to the embodiments described, which are provided by way of non-limiting illustration.

1. An assembled ceramic body comprising blocks attached to each other by means of a seal, the lateral surface of the ceramic body optionally being coated with a peripheral coating, the seal and/or the peripheral coating comprising a set cement, in a section plane perpendicular to at least one of the facing faces of the blocks assembled by said seal, having macropores with an equivalent diameter in the range 200 μm to 40 mm, in a quantity such that the total surface area in said section plane occupied by said macropores represents more than 15% and less than 80% of the total surface area observed, more than 50% by number of the macropores having an equivalent diameter in the range 500 μm to 5 mm.

2. A body according to claim 1, wherein the set cement comprises less than 10% of inorganic fibers, as a percentage by weight based on the dry mineral matter.

3. A body according to claim 1, wherein the set cement comprises a quantity of organic fibers of more than 0.1%, as a percentage by weight based on the dry mineral matter.

4. A body according to claim 1, wherein at least 80% by number of the macropores result from an interconnection of the cells of a foam.

5. A body according to claim 1, wherein the set cement comprises a quantity of organic fibers of more than 3% and less than 10%, as percentages by weight based on the dry mineral matter.

6. A body according to claim 1, wherein more than 5% by number of the macropores have an actual length and an actual width more than two times their actual thickness.

7. A body according to claim 1, wherein more than 50% by number of said macropores have a shape such that the ratio between their length and their width, measured in said section plane, is more than 2.

8. A body according to claim 1, wherein the total surface area occupied by said macropores represents, in said section plane, more than 20% and less than 50% of the total surface area observed.

9. A body according to claim 1, wherein in said section plane, more than 20% by number of the macropores have an equivalent diameter in the range 5 mm to 10 mm.

10. A body according to claim 1, wherein in said section plane, more than 5% by number of the macropores have an equivalent diameter of more than 10 mm.

11. A body according to claim 1, wherein the macropores in said seal extend substantially parallel to the faces of said blocks between which said seal is disposed.

12. A body according to claim 1, wherein the pore size distribution in said section plane comprises a first mode centered upon a dimension in the range 500 μm to 5 mm and a second mode centered upon a dimension in the range 1 μm to 50 μm.

13. A body according to claim 1, wherein more than 50% by number of the macropores extend substantially over the entire thickness of the seal, a thickness of cement of at least 50 μm being disposed between said macropores and said blocks.

14. A body according to claim 1, wherein the set cement comprises more than 5% of inorganic hollow spheres, as a percentage relative to the weight of the mineral matter.

15. A body according to claim 14, wherein the distribution of the inorganic hollow spheres falls into the following two fractions, for a total of 100% by weight:
a fraction representing in the range 60% to 80% by weight of the inorganic hollow spheres and having a median dimension of more than 110 μm and less than 150 μm; and
a fraction representing in the range 20% to 40% by weight of the inorganic hollow spheres and having a median dimension of more than 35 μm and less than 55 μm.

16. A body according to claim 1, wherein the total porosity of the set cement is more than 30% and less than 90%.

17. A body according to claim 1, wherein the set cement comprises more than 0.05% and less than 5% of a thermoset resin, as percentages relative to the weight of the dry mineral matter.

18. A body according to claim 1, wherein the set cement has a calcium oxide, CaO, content of less than 0.5% and/or comprises more than 50% of silicon carbide, as a percentage by weight relative to the dry mineral matter.

19. A body according to claim 1, wherein the silicon carbide, alumina, zirconia and silica represent more than 85% of the weight of the dry mineral matter of the set cement.

20. A body in accordance with claim 19, wherein the silicon carbide is present in the form of particles with a median dimension of less than 200 μm.

21. A body according to claim 1, wherein the set cement comprises, as a percentage by weight relative to the dry mineral matter, at least 5% of refractory particles having a size in the range 0.1 and 10 μm.

22. A body according to claim 1, wherein said blocks are filter blocks having more than 30% open porosity.

23. A body according to claim 1, said blocks comprising inlet channels and outlet channels, the overall volume of said inlet channels being more than that of said outlet channels.

24. A body according to claim 1, wherein said seal does not adhere over the whole contact surface with said blocks.

25. A body according to claim 1, wherein said blocks are not assembled by means of a continuous seal.

26. A body according to claim 1, wherein said section plane is a transverse median and/or longitudinal median section plane of the seal.

27. A method of producing an assembled filter body according to claim 1 comprising the following steps in succession:
a) preparing a fresh cement from a starting charge;
b) interposing said fresh cement between blocks to be assembled; and
c) setting said fresh cement with optional heat treatment;
wherein the starting charge comprises:
in the range 0.1% to 10% of organic fibers, as percentages by weight based on the dry mineral matter; and/or
in the range 0.5% to 10% of a foaming agent and in the range 0.05% to 5% of a gelling agent, as percentages by weight relative to the dry mineral matter; and/or
wherein a gas is caused to penetrate into the fresh cement in step a); and
optionally, wherein said starting charge comprises more than 5% of inorganic hollow spheres, as a percentage by weight based on the dry mineral matter.

28. A method according to claim 27, wherein, in step a), 0.5 to 2.5 liters of gas per liter of fresh cement is blown in.

29. A method according to claim 27, wherein the blocks to be assembled are immobilized during step c).

30. A method according to claim 27, wherein, in step c), setting is carried out at a temperature in the range 100° C. to 200° C.

31. A method according to claim 27, wherein, in step c), a heat treatment is carried out at a temperature in the range 400° C. to 1200° C.
